(19) United States
(12) Patent Application Publication
(10) Pub. No.: US 2009/0062064 A1
(43) Pub. Date: Mar. 5, 2009

(54) SHIFT CONTROL APPARATUS

(75) Inventors: Atsushi KAMADA, Nishikamo-gun (JP); Keiji Hoshino, Kariya-shi (JP); Shigeru Kamio, Nagoya-shi (JP)

Correspondence Address: SUGHRUE MION, PLLC, 2100 PENNSYLVANIA AVENUE, N.W., SUITE 800, WASHINGTON, DC, 20037, US

(73) Assignees: TOYOTA JIDOSHA KABUSHIKI KAISHA, Toyota-shi (JP); DENSO CORPORATION, Kariya-City (JP)

(21) Appl. No.: 12/198,922

(22) Filed: Aug. 27, 2008

(30) Foreign Application Priority Data
Aug. 31, 2007 (JP) 2007-227079

(51) Int. Cl. B60W 10/10

(52) U.S. Cl. 477/34

(57) ABSTRACT

A shift control apparatus is provided with a shift intention detecting device that electrically detects a shift intention of a driver; a shift driving device electrically controlled based on the shift intention; a shift mechanism; a first position information detecting device that detects, without contact, position information of the mechanical displacement of the shift mechanism; a shift position determining device that determines the shift position based on the position information; a second position information detecting device that detects the position information in a different way than the first position information detecting device does; a malfunction determining device that determines whether the position information detected by the first position information detecting device is erroneous; and a switching device that switches from control based on the first position information detecting device to control based on the second position information detecting device when it has been determined that the position information detected by the first position information detecting device is erroneous.

### INCORPORATION BY REFERENCE

The disclosure of Japanese Patent Application No. 2007-227079 filed on Aug. 31, 2007, including the specification, drawings and abstract is incorporated herein by reference in its entirety.

### BACKGROUND OF THE INVENTION

1. Field of the Invention

The invention relates to a shift control apparatus. More particularly the invention relates to an improvement of a shift control apparatus that determines a shift position based on position information of the mechanical displacement of a shift mechanism.

2. Description of the Related Art

A so-called shift-by-wire shift control apparatus is known which includes a shift intention detecting device that electrically detects a shift intention of a driver, a shift mechanism that is mechanically displaced into any one of a plurality of shift positions by a shift driving device that is electrically driven based on that shift intention of the driver, a position information detecting device that detects position information of the mechanical displacement of the shift mechanism, and a shift position determining device that determines the shift position based on that position information. The vehicular shift control apparatus described in Japanese Patent Application Publication No. 2004-308847 (JP-A-2004-308847) is one such example. In this shift control apparatus, a restricting device mechanically restricts the end position of movement (such as the park position) of the shift driving device, and learns that end position of movement as a reference position so that even in a case in which relative position information (such as the number of pulses of a rotary encoder) is detected by the position information detecting device, the shift position can be determined based on that relative position information.

In the shift control apparatus described in JP-A-2004-308847, the switching of the shift range is determined according to the shift position of which there are two, i.e., one for a P (park) range and one for a non-P range. However, when there are four shift positions e.g., P (park), R (reverse), N (neutral), and D (drive), the accuracy of the value detected by a rotary encoder which detects the relative position information may decrease as a result of play and the likes.

On the other hand, a noncontact sensor that detects absolute positional information is also known. This noncontact sensor is able to detect the angle using a magnet and a magnetic element. Simply put, the operating principle of a noncontact sensor is such that when the magnet moves, magnetic force and magnetic flux and the like which travel through the element change so the resistance value and the like of the element changes. As a result, the value of the voltage traveling through the element changes. Here, the change in the amount of movement of the magnet and the voltage value is uniquely set so the rotation angle can be detected by detecting this output voltage value. However, when a strong magnetic force or the like is applied to the noncontact sensor from an external source, the magnetic force and magnetic flux and the like that travel through the magnet become disrupted, changing the voltage value. As a result, the correct rotation angle may not be able to be calculated, which may result in a decrease in the accuracy of the motor control.

### SUMMARY OF THE INVENTION

This invention thus provides a shift control apparatus that is able to more accurately determine a shift position based on position information of mechanical displacement of a shift mechanism even if an output value of a noncontact sensor is erroneous due to magnetic force or the like from an external source, for example.

A first aspect of the invention relates to a shift control apparatus that includes a i) shift intention detecting device that electrically detects a shift intention of a driver; ii) a shift driving device that is electrically controlled based on the shift intention of the driver; iii) a shift mechanism that is mechanically displaced into any one of a plurality of shift positions by the shift driving device; iv) a first position information detecting device that detects, without contact, position information of the mechanical displacement of the shift mechanism; v) a shift position determining device that determines the shift position based on the position information; vi) a second position information detecting device that detects the position information of the mechanical displacement of the shift mechanism in a different way than the first position information detecting device does; vii) a malfunction determining device that determines whether the position information detected by the first position information detecting device is erroneous; and viii) a switching device that switches from control based on the first position information detecting device to control based on the second position information detecting device when it has been determined that the position information detected by the first position information detecting device is erroneous.

As described above, this shift control apparatus includes a second position information detecting device that detects the position information of the mechanical displacement of the shift mechanism in a different way than the first position information detecting device does; a malfunction determining device that determines whether the position information detected by the first position information detecting device is erroneous; and a switching device that switches from control based on the first position information detecting device to control based on the second position information detecting device when it has been determined that the position information detected by the first position information detecting device is erroneous. Therefore, for example, if the first position information detecting device malfunctions, the malfunction determining device detects that malfunction and switches from control based on the first position information detecting device to control based on the second position information detecting device. As a result, it is possible to always switch to the correct shift position that is based on the shift intention of the driver.

### BRIEF DESCRIPTION OF THE DRAWINGS

The features, advantages, and technical and industrial significance of this invention will be described in the following detailed description of example embodiments of the invention with reference to the accompanying drawings, in which like numerals denote like elements, and wherein:

FIG. 1 is a skeleton view of a vehicular drive system to which the invention may be suitably applied;

FIG. 2 is a clutch and brake application chart showing the relationship between the application state of the clutches and brakes, i.e., friction apply devices and the various gear speeds in an automatic transmission shown in FIG. 1;

FIG. 3 is a circuit diagram showing a manual valve and portions related to the clutches and the brakes in a hydraulic control circuit provided in the vehicular drive system shown in FIG 1;

FIG. 4 is a block line diagram illustrating a control system for electrically switching shift positions of the manual valve according to an operation of a shift operating device in the vehicular drive system shown in FIG. 1;

FIG. 5 is a block diagram schematically showing a noncontact position sensor shown in FIG. 4;

FIG. 6 is a block line diagram showing the functions of an electronic control unit shown in FIG. 4 with respect to shift control;

FIG. 7 is a graph showing the correlation between the position voltage and the shift position, which is stored in a reference value storing device shown in FIG. 6;

FIG. 8 is a graph showing the correlation between the pulse count and the shift position, which is stored in a motor data storing device shown in FIG. 6; and

FIG. 9 is a flowchart illustrating a main function of the electronic control unit, i.e., shift position switching control which is executed if the noncontact position sensor malfunctions.

### DETAILED DESCRIPTION OF THE EMBODIMENTS

Example embodiments of the present invention will be described in greater detail below with reference to the accompanying drawings.

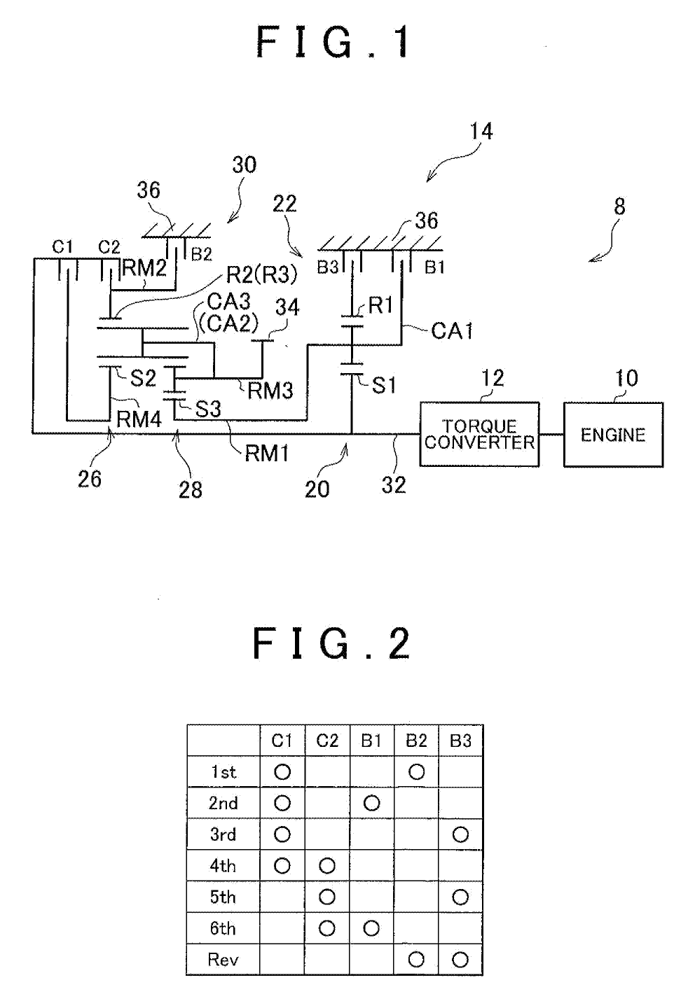

FIG. 1 is a skeleton view of a transverse mounted vehicular drive system 8 for a FF (front engine-front drive) vehicle or the like. In this vehicular drive system 8, output from an engine 10 which is an internal combustion engine such as a gasoline engine or a diesel engine, is transmitted through a torque converter 12 and an automatic transmission 14 to driving wheels (i.e., front wheels) from a differential gear unit, not shown. The engine 10 is a power source (i.e., a prime mover) for running the vehicle, and the torque converter 12 is a coupling that uses fluid.

The automatic transmission 14 has a first transmitting portion 22 and a second transmitting portion 30 arranged on the same axis. The first transmitting portion 22 has as its main component a single pinion type first planetary gear set 20, while the second transmitting portion 30 has as its main components a single pinion type second planetary gear set 26 and a double pinion type third planetary gear set 28. The automatic transmission 14 uses these first and second transmitting portions 22 and 30 to appropriately change the rate and/or direction of rotation that is input from an input shaft 32 and outputs the changed rotation from an output gear 34. The input shaft 32 corresponds to an input member, and in this example embodiment is a turbine shaft of the torque converter 12. The output gear 34 corresponds to an output member which drives the left and right driving wheels via the differential gear unit. Incidentally, the automatic transmission 14 has a generally symmetrical structure with respect to its center line so the half below the center line is omitted in FIG. 1.

The first planetary gear set 20 which is made up of the first transmitting portion 22 has three rotating elements, i.e., a sun gear S1, a carrier CA1, and a ring gear R1. The carrier CA1 as an intermediate output member is made to rotate slower than the input shaft 32 by rotating the sun gear S1 which is connected to the input shaft 32 and holding the ring gear R1 stationary by a third brake B3 that locks it to a transmission case 36. Further, four rotating elements RM1 to RM4 are formed by portions of the second planetary gear set 26 and the third planetary gear set 28, which together constitute the second transmitting portion 30, that are connected together. More specifically, a sun gear S3 of the third planetary gear set 28 forms the first rotating element RM1. A ring gear R2 of the second planetary gear set 26 and a ring gear R3 of the third planetary gear set 28 are connected together and form the second rotating element RM2. A carrier CA2 of the second planetary gear set 26 and a carrier CA3 of the third planetary gear set 28 are connected together and form the third rotating element RM3, and a sun gear S2 of the second planetary gear set 26 forms the fourth rotating element RM4. The second planetary gear set 26 and the third planetary gear set 28 together form a Ravigneaux type planetary gear train in which the carrier CA2 and the carrier CA3 are a common member, the ring gear R2 and the ring gear R3 are a common member, and the pinion gear of the second planetary gear set 26 also serves as a second pinion gear of the third planetary gear set 28.

The first rotating element RM1 (sun gear S3) is selectively connected to the transmission case 36 by a first brake B1 so as to be prevented from rotating. Similarly, the second rotating element RM2 (ring gears R2 and R3) is selectively connected to the transmission case 36 by a second brake B2 so as to be prevented from rotating. Further, the fourth rotating element RM4 (sun gear S2) is selectively connected to the input shaft 32 via a first clutch C1, while the second rotating element RM2 (the ring gears R2 and R3) is selectively connected to the input shaft 32 via a second clutch C2. The first rotating element RM1 (sun gear S3) is integrally connected to the carrier CA1 of the first planetary gear set 20 which serves as the intermediate output member. The third rotating element RM3 (carriers CA2 and CA3) is integrally connected with the output gear 34 and outputs rotation.

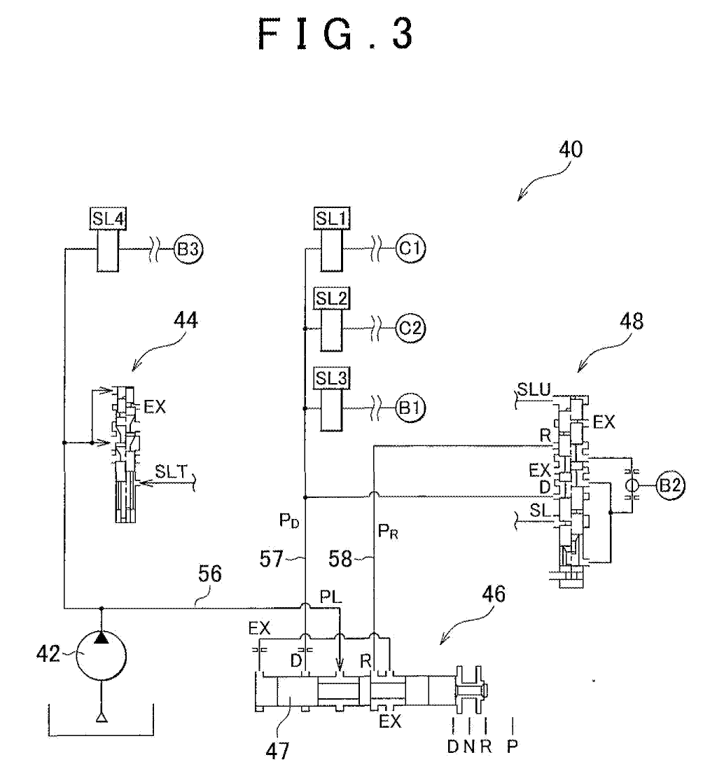

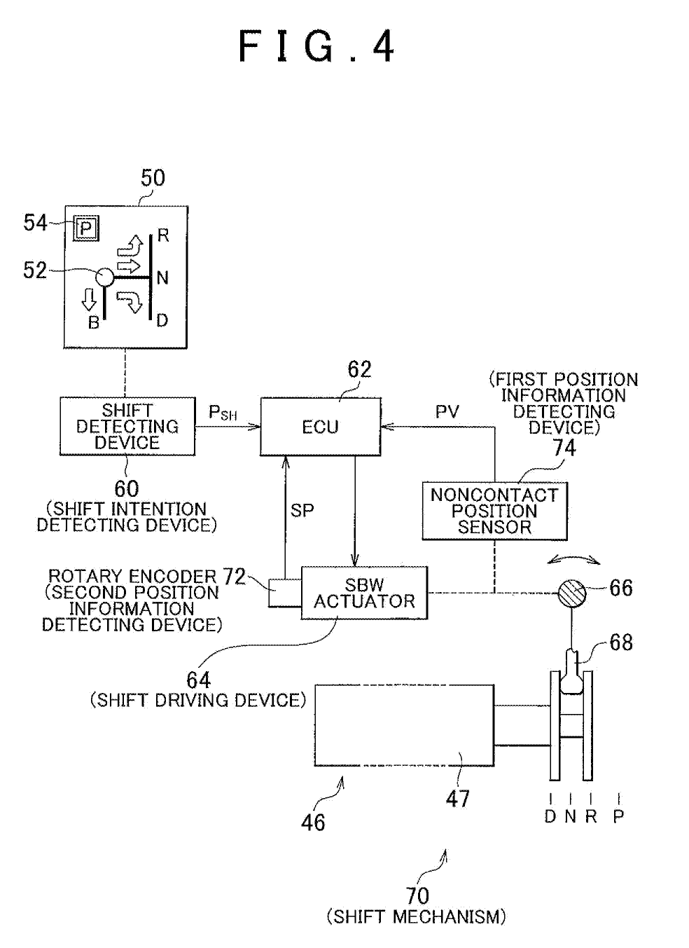

The clutches C1 and C2 and the brakes B1, B2, and B3 (hereinafter simply referred to as clutches C and brakes B when there in no need to specify the specific clutch or brake) are all hydraulic friction apply devices, such as multiple-disc clutches and brakes, which are controlled to apply friction using hydraulic actuators. Six forward gear speeds and one reverse gear speed, as shown in FIG. 2, can be established according to the shift position P_{SH} of a shift operating device 50 (shown in FIG. 4) by selectively applying and releasing these clutches C and brakes B using a hydraulic control circuit 40 shown in FIG. 3. The denotations “1st” to “6th” in FIG. 2 refer to the six forward gear speeds, i.e., first gear to sixth gear, respectively, and “REV” refers to reverse gear. The speed ratios (=input shaft rotation speed NIN/output shaft rotation speed NOUT) of these gear speeds are set appropriately according to the gear ratio ρ1 of the first planetary gear set 20, the gear ratio ρ2 of the second planetary gear set 26, and the gear ratio ρ3 of the third planetary gear set 28. The circles in FIG. 2 indicate an applied state and the absence of a circle indicates a released state.

In FIG. 3, the hydraulic control circuit 40 includes a mechanical oil pump 42 that is driven by the engine 10, a primary regulator valve 44, a manual valve 46, linear solenoid valves SL1 to SL4, and a B2 control valve 48 and the like. Hydraulic fluid drawn up by the oil pump 42 is adjusted to a predetermined line pressure PL according to the accelerator operation amount (i.e., the amount of output required by the driver) by the primary regulator valve 44 which receives a signal pressure from a linear solenoid valve SLT, not shown. Then the third brake B3 is controlled to apply or release by controlling the apply pressure using the linear solenoid valve SL4 to which the line pressure PL is supplied as it is.

The manual valve 46 switches the oil path according to operation of the shift operating device 50 to i) supply forward running pressure P_{D} to the B2 control valve 48 and the linear solenoid valves SL1 to SL3 arranged corresponding to the clutches C1 and C2 and the first brake B1, ii) supply reverse running pressure P_{R} to the B2 control valve 48, or iii) stop the supply of hydraulic pressure to those valves. The shift operating device 50 is operated according to the shift intention of the driver, and is provided with a shift lever 52 and a push-button type P switch 54 that is pushed upon parking. The shift lever 52 is operated by being moved into one of four positions as shown in FIG. 4, i.e., “R (Reverse)” for reverse running, “N (Neutral)” which interrupts the transmission of power, “D (Drive)” for forward running, and “B (Brake)” for using the engine brake. The shift lever 52 is a momentary type shift lever that always automatically returns to the center position shown in the drawing, and includes a shift detecting device 60 (which corresponds to the shift intention detecting device of this invention) that detects a shift into any one of the operating positions described above, i.e., “R”, “N”, “D”, and “B”. This shift detecting device 60 electrically detects the shift position P_{SH} from among those positions, including an ON operation of the P switch 54 (i.e., operating position “P”), i.e., detects the shift intention of the driver. Then the electronic control unit (ECU) 62 controls an SBW (shift-by-wire) actuator 64 according to the detected shift position P_{SH}, so that a switching shaft 66 is rotated around its axis, which mechanically moves a spool (i.e., a valve body) 47 of the manual valve 46 via a lever 68 in a linear direction. As a result, the shift position switches to one of the four shift positions “P”, “R”, “N”, and “D”, thereby switching the hydraulic pressure path. Incidentally, when the shift position P_{SH} is “B”, it is given that the vehicle is running forward in “D” so the engine brake is increased by electrically executing shift control while keeping the manual valve 46 in the shift position “D”.

The shift position “D” of the manual valve 46 is a forward driving position used for forward running. As is evident from FIG. 3, in this shift position “D”, the manual valve 46 is in a state connecting a supply passage 56 to which the line pressure PL is supplied with the forward running passage 57, such that forward running pressure P_{D} equivalent to the line pressure PL is output to that forward running passage 57. The forward running passage 57 is connected to the linear solenoid valves SL1 to SL3 and the B2 control valve 48 so by controlling (i.e., adjusting) the forward running pressure P_{D} using those valves, the clutches C1 and C2 and the brakes B1 and B2, respectively, are applied or released. This, in combination with applying or releasing the third brake B3, establishes one of the six forward gear speeds, i.e., first gear “1st” to sixth gear “6th”. A signal pressure is supplied from solenoid valves SLU and SL, not shown, to the B2 control valve 48, and the apply pressure of the second brake B2 is controlled based on the signal pressure of the solenoid valve SLU.

The shift position “R” of the manual valve 46 is a reverse driving position used for reverse running. In this shift position “R”, the manual valve 46 is in a state connecting the supply passage 56 to which the line pressure PL is supplied with the reverse running passage 58, such that a reverse running pressure P_{R} equivalent to the line pressure PL is output to that reverse running passage 58. The reverse running passage 58 is connected to the B2 control valve 48 so by supplying the reverse pressure P_{R} to the second brake B2 via this B2 control valve 48, the second brake B2 is applied. Applying the third brake B3 in combination with this establishes reverse “R”.

The shift position “P” of the manual valve 46 is a parking position which interrupts the transmission of power from the source of driving force, and mechanically prevents the driving wheels from rotating by a parking lock device, not shown. In the shift position “P” the manual valve 46 closes off communication between the supply passage 56 to which the line pressure PL is supplied and both the forward running passage 57 and the reverse running passage 58, and opens up communication between the forward running passage 57 and the reverse running passage 58 and an EX port to drain the hydraulic fluid. Also, the shift position “N” is a position that interrupts the transmission of power from the source of driving force. In the shift position “N”, the manual valve 46 closes off communication between the supply passage 56 to which the line pressure PL is supplied and both the forward running passage 57 and the reverse running passage 58, and opens up communication between the reverse passage 58 and the EX port to drain the hydraulic fluid. The manual valve shown in FIG. 3 is in this shift position “N”. The manual valve 46 corresponds to a drive switching valve, and the spool 47 corresponds to the valve body.

In this example embodiment, there is a shift mechanism 70 that includes the manual valve 46 and the switching shaft 66. This shift mechanism 70 mechanically switches into any one of a plurality of shift positions which determine the driving state of the vehicle. The SBW actuator 64 corresponds to the shift driving device that is electrically controlled based on the shift intention of the driver. In this example embodiment, this SBW actuator 64 is formed by a SR motor (Switched Reluctance motor) which is connected to the switching shaft 66 via a reduction gear and the like and which drives the switching shaft 66. Also, a pulse signal SP output from a rotary encoder 72 that is integrally provided with the SBW actuator 64 is supplied to the electronic control unit 62. The rotary encoder 72 is a noncontact optical rotation sensor that has both a light emitting element and a light receiving element. This rotary encoder 72 outputs a pulse signal SP every predetermined number of rotations of the SBW actuator 64. This rotary encoder 72 also functions as a second position information detecting device that continuously detects relative position information of the mechanical displacement of the shift mechanism 70, in this case, the rotational displacement of the switching shaft 66. The pulse signal SP corresponds to the relative position information.

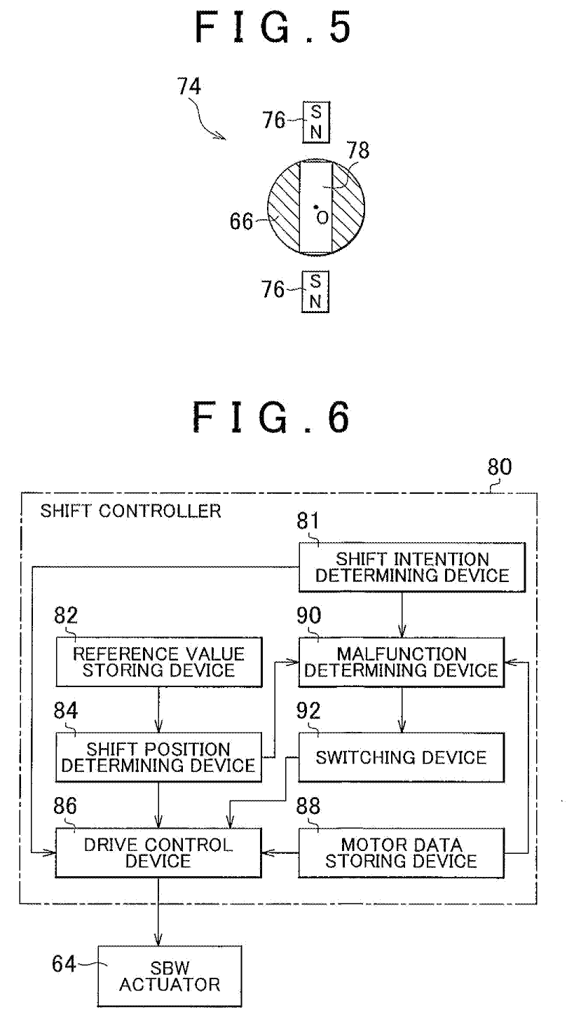

A noncontact position sensor 74 is also mounted to the switching shaft 66. This noncontact position sensor 74 is a noncontact rotation angle sensor that detects absolute position information of the mechanical displacement of the shift mechanism 70, in this case, the rotational displacement (i.e., mechanical displacement) of the switching shaft 66, and functions as a first position information detecting device. As shown in FIG. 5, the noncontact position sensor 74 includes a pair of magnets 76 arranged symmetrically with respect to an axis O around the switching shaft 66, and a Hall element 78 that is integrally arranged on the switching shaft 66 and thus rotates about the axis O together with the switching shaft 66. The Hall element 78 outputs a position voltage PV that changes according to the strength of magnetic force acting on the Hall element 78, and the magnetic force acting on the Hall element 78 changes according to the rotation of the switching shaft 66. Therefore, the position voltage PV continuously changes according to the rotation angle of the switching shaft 66. As a result, the rotation angle of the switching shaft 66, and further, the shift position “P”, “R”, “N”, or “D” of the manual valve 46, can be detected based on the amount of this position voltage PV. The position voltage PV corresponds to the absolute position information.

The electronic control unit 62 is formed of a microcomputer that has a CPU, RAM and ROM and the like. This electronic control unit 62 performs a variety of functions by processing signals according to programs stored in advance. FIG. 6 is a block line diagram showing the function of a shift controller 80 that is performed by the electronic control unit 62 when controlling the SBW actuator 64 to switch the manual valve 46 according to a shift operation SH of the shift operating device 50. As shown in the drawing, the shift controller 80 includes a shift intention determining device 81, a reference value storing device 82, a shift position determining device 84, a drive control device 86, and a motor data storing device 88.

The shift intention determining device 81 determines whether the shift position is being switched, including an ON operation of the P switch 54, according to the shift position P_{SH} detected by the shift detecting device 60 (i.e., the shift intention detecting device).

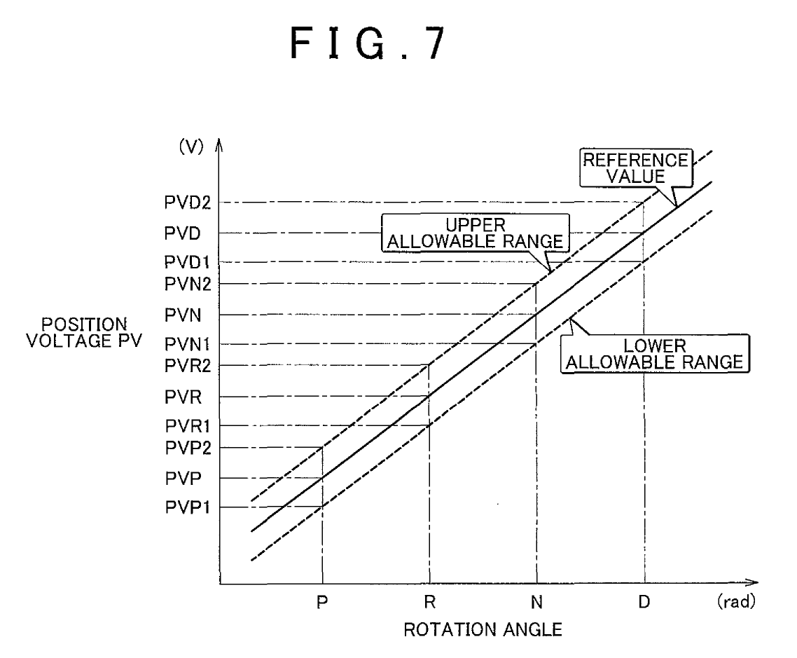

The reference value storing device 82 stores the correlation, obtained upon shipping from the factory beforehand, between the position voltage PV output from the noncontact position sensor 74 and the four shift positions “P”, “R”, “N”, and “D” of the manual valve 46, i.e., the rotation angle of the switching shaft 66 about its axis O. The solid line in FIG. 7 is an example of a reference value of this correlation. The noncontact position sensor 74 is structured such that the position voltage PV changes generally linearly with respect to the rotation angle of the switching shaft 66. Also, a predetermined upper allowable range and a predetermined lower allowable range are set above and below, respectively, the reference level, as shown by the broken lines, taking into account, for example, variation (individual differences) in the detection accuracy of the noncontact position sensor 74 and changes in the position voltage PV caused by temporary disturbances such as changes in temperature. In this example embodiment, the upper allowable range and the lower allowable range are set equal distances above and below the reference value, for example, but they may also be set at different distances from the reference value. Incidentally, a graph such as that shown in FIG. 7 is not always necessary. Alternatively, a correlation between the allowable ranges and the reference value of the position voltage PV may also be set for each shift position “P”, “R”, “N”, and “D”.

The shift position determining device 84 determines whether the current shift position is “P”, “R”, “N”, or “D” based on the position voltage PV corresponding to the position information, or more specifically, based on the upper allowable range and the lower allowable range stored in the reference value storing device 82. That is, the shift position determining device 84 determines that the shift position of the manual valve 46 is “P” if the position voltage PV is within the range of PVP1 to PVP2, “R” if the position voltage PV is within the range of PVR1 to PVR2, “N” if the position voltage PV is within the range of PVN1 to PVN2, and “D” if the position voltage PV is within the range of PVD1 to PVD2.

Then the drive control device 86 compares the shift position of the manual valve 46 determined by the shift position determining device 84 with the shift position P_{SH} detected by the shift detecting device 60, and feedback-controls the SBW actuator 64 so that the shift position of the manual valve 46 comes to match the shift position P_{SH}. That is, feedback control is performed so that the position voltage PV becomes a voltage value to achieve the shift position corresponding to the shift position P_{SH}. More specifically, feedback control is performed so that the position voltage PV becomes PVP, which is the reference voltage, when the shift position corresponding to the shift position P_{SH} is the “P” position, PVR when the shift position corresponding to the shift position P_{SH} is the “R” position, PVN when the shift position corresponding to the shift position P_{SH} is the “N” position, and PVD when the shift position corresponding to the shift position P_{SH} is the “D” position.

Here, if the value of the position voltage PV of the Hall element 78 becomes abnormal due to, for example, deterioration with age, a change in the environmental temperature, or disturbance magnetism from any of a variety of electronic components or the like onboard the vehicle when the SBW actuator 64 is feedback-controlled based on the position voltage PV output from the noncontact position sensor 74 as described above, the accuracy of control by the SBW actuator 64 deteriorates so a switch to the target shift position may not be possible. More specifically, if there is a malfunction while the shift position is being switched, the switch may be into a different shift position than the target shift position.

However, the shift controller 80 (i.e., the shift control system) of this example embodiment is also provided with a malfunction determining device 90 and a switching device 92 so that even if the position voltage PV of the Hall element 78 becomes abnormal (i.e., erroneous), the shift position can still be switched correctly.

The malfunction determining device 90 compares the absolute position information of the rotation angle of the switching shaft 66 from the noncontact position sensor 74 which functions as the first position information detecting device, with the relative position information of the rotation angle of the switching shaft 66 from the rotary encoder 72 which functions as the second position information detecting device that detects according to a different method than the first position information detecting device does. Then the malfunction determining device 90 determines whether the position information detected by the noncontact position sensor 74 is erroneous.

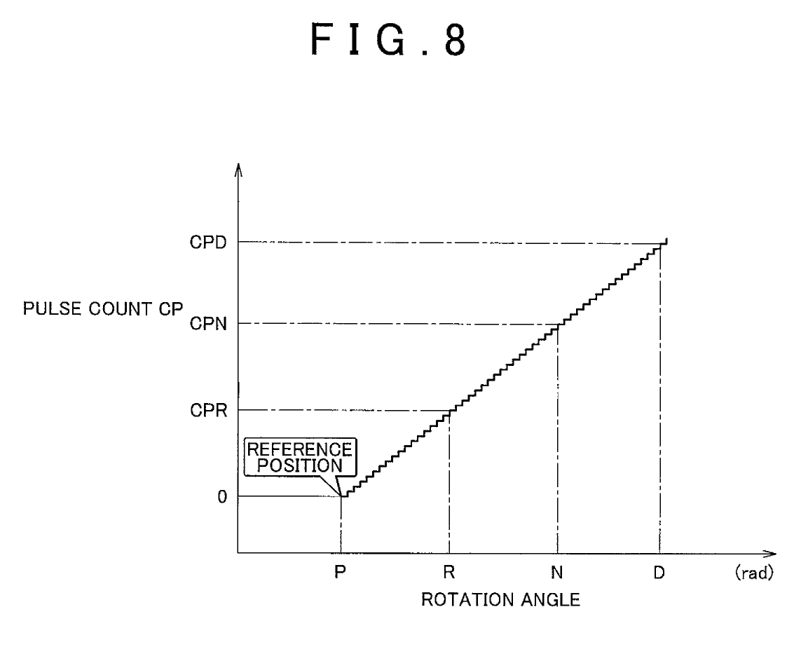

Here, the rotation angle (i.e., the position information) of the switching shaft 66 from the noncontact position sensor 74 is calculated based on the relationship between the position voltage PV and the rotation angle of the switching shaft 66, which is shown in FIG. 7 as described above. Also, the rotation angle (i.e., the position information) of the switching shaft 66 from the rotary encoder 72 is calculated based on the motor data which is stored in the motor data storing device 88. The motor data that is stored in the motor data storing device 88 is a correlation between the number of pulse signals SP output from the rotary encoder 72 (i.e., the pulse count CP) and the rotation angle of the switching shaft 66 around its axis O. This correlation is obtained beforehand upon shipping from the factory, with the “P” position, which is the shift position when the ignition switch is turned on, set as the reference position (i.e., the reference angle), for example. FIG. 8 shows one example of this motor data. Therefore, the pulse count CP is detected by the rotary encoder 72 and the rotation angle of the switching shaft 66 is calculated based on that pulse count CP, and the shift position “P”, “R”, “N”, or “D” that is primarily set based on the pulse count CP is determined.

The malfunction determining device 90 compares the rotation angle (i.e., the position information) of the switching shaft 66 calculated by the noncontact position sensor 74 with the rotation angle (i.e., the position information) of the switching shaft 66 calculated by the rotary encoder 72, and determines that the position voltage PV of the noncontact position sensor 74 is erroneous when the difference between the two calculated rotation angles continues to be greater than a predetermined reference for more than a predetermined period of time t1. Incidentally, the predetermined reference and the predetermined period of time t1 are obtained in advance through testing, and are set to suitable values at which an abnormal position voltage PV can be accurately determined.

When the malfunction determining device 90 determines that the position voltage PV of the noncontact position sensor 74 is erroneous, the switching device 92 switches from shift control based on the noncontact position sensor 74 to control based on the rotary encoder 72. At this time, the drive control device 86 controls the SBW actuator 64 based on the pulse count CP output from the rotary encoder 72. More specifically, the drive control device 86 compares the shift position P_{SH} detected by the shift detecting device 60 with the shift position determined based on the pulse count CP of the pulse signals SP output from the rotary encoder 72, and controls the SBW actuator 64 based on the motor data stored in the motor data storing device 88 so that the shift position of the manual valve 46 comes to match the shift position P_{SH}. Therefore, it is sufficient to simply obtain the pulse count CP from the current shift position to the shift position corresponding to the shift position P_{SH} and drive the SBW actuator 64 in the forward and reverse directions so that the pulse signal SP is supplied only the number of times equal to the pulse count CP. For example, if the current shift position is “P” and the shift position P_{SH} changes from “P” to “D”, the SBW actuator 64 need simply be driven so that the pulse signal SP shown in FIG. 8 is supplied only the number of times equal to the pulse count CPD. Conversely, if the current shift position is “D” and the shift position P_{SH} changes from “D” to “N” or “R”, the SBW actuator 64 need simply be driven in the reverse direction so that the pulse signal SP is supplied only the number of times equal to the pulse count (CPD−CPN) or (CPD−CPR).

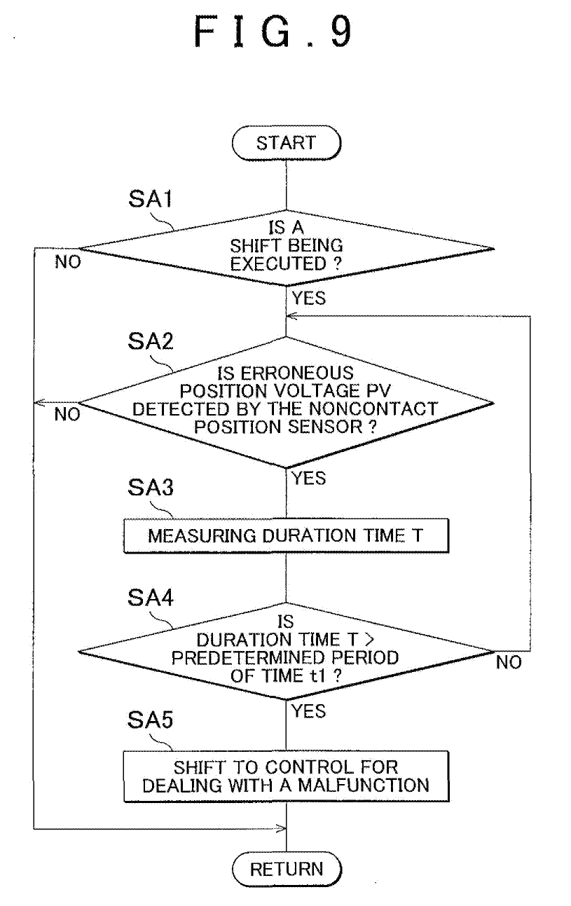

FIG. 9 is a flowchart of a main function of the electronic control unit 62, i.e., a routine for controlling the SBW actuator 64 based on the pulse count CP output from the rotary encoder 72 when the position voltage PV detected by the noncontact position sensor 74 is erroneous.

First, in step SA1 which corresponds to the shift intention determining device 81, it is determined whether the shift position is being switched based on the shift position P_{SH}. Incidentally, switching of the shift position can be determined by determining whether the position voltage PV output from the noncontact position sensor 74 is changing. If the amount of change in the position voltage PV is equal to or greater than a predetermined value it can be determined that the shift position is being switched. Further, the pulse count CP of the rotary encoder 72 can also be detected and switching of the shift position determined based on the change in that count CP.

If the determination in step SA1 is No, this cycle of the routine ends. If, on the other hand, the determination in step SA1 is Yes, then it is determined in step SA2, which corresponds to the malfunction determining device 90, whether the position voltage PV detected by the noncontact position sensor 74 is erroneous. More specifically, the rotation angle of the switching shaft 66 calculated based on the position voltage PV detected by the noncontact position sensor 74 is compared with the rotation angle of the switching shaft 66 calculated based on the pulse count CP output from the rotary encoder 72, and it is determined whether the difference between these two calculated rotation angles is greater than a predetermined reference. If the difference between the rotation angles is less than the predetermined reference, this cycle of the routine ends.

If, on the other hand, the difference between the rotation angles is greater than the predetermined reference, then in step SA3 which corresponds to the malfunction determining device 90, the duration time T during which the difference between the rotation angles is greater than the predetermined reference starts to be measured from the point at which the difference in the rotation angles becomes larger than the predetermined reference. Then in step SA4 which corresponds to the malfunction determining device 90, it is determined whether the duration time T has exceeded the predetermined period of time t1. If the determination in step SA4 is No, then steps SA2 and thereafter are executed again. If the duration time T has exceeded the predetermined period of time t1, then the determination in step SA4 is Yes so the process proceeds on to step SA5. In step SA5, which corresponds to the switching device 92 and the drive control device 86, the method of control of the SBW actuator 64 that is executed switches from feedback control according to the position voltage PV detected by the noncontact position sensor 74 to control based on the pulse count CP output from the rotary encoder 72. As a result, even if the noncontact position sensor 74 malfunctions, the shift position can be switched correctly by switching to the control method based on the rotary encoder 72.

Incidentally, even if a shift is not in the middle of being performed, if the malfunction determining device 90 is operated and it is determined that the noncontact position sensor 74 is malfunctioning at that time, a control command to prohibit a shift from being executed thereafter can also be output to the shift controller 80.

As described above, in this example embodiment, the shift control apparatus is provided with i) the rotary encoder 72 (i.e., the second position information detecting device) which detects position information of the mechanical displacement of the shift mechanism 70 by in a different way than the noncontact position sensor 74 (i.e., the first position information detecting device) does, ii) the malfunction determining device 90 which determines whether the position information detected by the noncontact position sensor 74 is erroneous, and iii) the switching device 92 which switches from detection based on the noncontact position sensor 74 to detection based on the rotary encoder 72 when it is determined that the position information detected by the noncontact position sensor 74 is erroneous. Accordingly, for example, if the noncontact position sensor 74 malfunctions, the malfunction determining device 90 detects that malfunction and control is executed switching from the noncontact position sensor 74 to the rotary encoder 72, which makes it possible to always switch to the correct shift position that is based on the shift intention of the driver.

Also according to this example embodiment, the malfunction determining device 90 determines that the position information detected by the noncontact position sensor 74 is erroneous (i.e., that there is a malfunction) when the difference between the position information detected by the noncontact position sensor 74 and the position information detected by the rotary encoder 72 continues to be greater than the predetermined reference for more than the predetermined period of time t1. As a result, it possible to accurately determine that error (i.e., malfunction) based on the continued difference in the position information.

Also, according to this example embodiment, the noncontact position sensor 74 is a noncontact rotation angle sensor that detects the rotation angle of a magnet, while the rotary encoder 72 outputs a pulse according to the amount of rotational displacement. Therefore, even if the position information detected by the noncontact position sensor 74 is erroneous, the shift position can still be accurately determined based on the relative position information from the rotary encoder 72.

Also, according to this example embodiment, the SBW actuator 64 is feedback-controlled based on the position voltage PV output by the noncontact position sensor 74 so a correct shift (i.e., a sketch to the correct shift position) is possible when the noncontact position sensor 74 is operating normally.

Moreover, according to this example embodiment, when a malfunction is detected in the noncontact position sensor 74 by the malfunction determining device 90 at a time other than during a shift, a shift is prohibited from being executed thereafter so it is possible reliably avoid the possibility of erroneous operation during a shift.

Although example embodiments of the invention have been described in detail based on the drawings, the invention may also be applied in other modes.

For example, the shift intention detecting device in the foregoing example embodiment need only be able to convert a shift intention of the driver into an electric signal. Accordingly, various modes are possible such as for example a push-button type switch or a lever position sensor that detects the operating position of a shift lever, or a momentary type detection device that detects and stores the operating position of an operating lever that automatically returns to its original position such as a center position.

Further, the first position information detecting device in the foregoing example embodiment is formed by a noncontact rotation angle sensor that has a magnetoresistive element or a Hall element for detecting magnetic force that changes according to the rotation angle, for example. However, various modes are possible such as a gap sensor that detects, without contact, a plurality of shift positions of a member that is moved linearly, for example. Also, various modes, both contact and noncontact types, such as a magnescale that outputs a pulse according to the rotation angle, for example, are possible for the second position information detecting device.

Also, in the foregoing example embodiment, the vehicle is driven by an engine that generates power by combusting fuel. Alternatively, however, the shift control apparatus of the invention may also be appropriately applied to various other types of vehicles, such as an electric vehicle which is driven by an electric motor, or a hybrid vehicle which has a plurality of power sources. Also, the shift control apparatus of the invention may also be applied to any of a variety of types of vehicles which have a forward/reverse switching device that switches between forward and reverse, a stepped automatic transmission having a plurality of gear speeds with different speed ratios, or a continuously variable transmission that continuously changes speed ratios, and which can change drive states via a shift mechanism.

Furthermore, the automatic transmission in the foregoing example embodiment is the stepped automatic transmission 14, but the structure of the automatic transmission is not limited to that in the example embodiment. That is, the number of planetary gear sets, the number of gear speeds, and the number of clutches C and brakes B, as well as the elements of the planetary gear sets to which the clutches C and brakes B are selectively connected, and the like are not particularly limited.

While the invention has been described with reference to exemplary embodiments thereof, it is to be understood that the invention is not limited to the exemplary embodiments or constructions. To the contrary, the invention is intended to cover various modifications and equivalent arrangements. In addition, while the various elements of the exemplary embodiments are shown in various combinations and configurations, which are exemplary, other combinations and configurations, including more, less or only a single element, are also within the spirit and scope of the invention.

What is claimed is:

1. A shift control apparatus comprising:
a shift intention detecting device that electrically detects a shift intention of a driver;
a shift driving device that is electrically controlled based on the shift intention of the driver;
a shift mechanism that is mechanically displaced into any one of a plurality of shift positions by the shift driving device;
a first position information detecting device that detects, without contact, position information of the mechanical displacement of the shift mechanism;
a shift position determining device that determines the shift position based on the position information;
a second position information detecting device that detects the position information of the mechanical displacement of the shift mechanism in a different way than the first position information detecting device does;
a malfunction determining device that determines whether the position information detected by the first position information detecting device is erroneous; and
a switching device that switches from control based on the first position information detecting device to control based on the second position information detecting device when it has been determined that the position information detected by the first position information detecting device is erroneous.

2. The shift control apparatus according to claim 1, wherein the malfunction determining device determines that the position information detected by the first position information detecting device is erroneous when a difference between the position information detected by the first position information detecting device and the position information detected by the second position information detecting device continues to be greater than a predetermined reference for more than a predetermined period of time.

3. The shift control apparatus according to claim 1, wherein the position information is a rotation angle, and the first position information detecting device is a noncontact rotation angle sensor that continuously detects the rotation angle of a magnet, and the second position information detecting device is a rotary encoder that outputs a pulse according to an amount of rotational displacement of a shaft of the shift mechanism.

4. The shift control apparatus according to claim 3, wherein the first position information detecting device is a noncontact rotation angle sensor having a Hall element.

5. The shift control apparatus according to claim 3, wherein the first position information detecting device is a noncontact rotation angle sensor having a magnetoresistive element.

6. The shift control apparatus according to claim 1, wherein the position information is a rotation angle, and the first position information detecting device is a noncontact rotation angle sensor that continuously detects the rotation angle of a magnet, and the second position information detecting device is a magnescale that outputs a pulse according to the rotation angle of a shaft of the shift mechanism.

7. The shift control apparatus according to claim 6, wherein the first position information detecting device is a noncontact rotation angle sensor having a Hall element.

8. The shift control apparatus according to claim 6, wherein the first position information detecting device is a noncontact rotation angle sensor having a magnetoresistive element.

9. The shift control apparatus according to claim 1, wherein the position information is a linear displacement amount, and the first position information detecting device is a gap sensor that continuously detects the position of a member that moves linearly, and the second position information detecting device is a rotary encoder that outputs a pulse according to an amount of rotational displacement of a shaft of the shift mechanism.

10. The shift control apparatus according to claim 1, wherein the position information is a linear displacement amount, and the first position information detecting device is a gap sensor that continuously detects the position of a member that moves linearly, and the second position information detecting device is a magnescale that outputs a pulse according to a rotation angle of a shaft of the shift mechanism.

11. The shift control apparatus according to claim 1, wherein the shift driving device is feedback-controlled based on a position voltage output from the first position information detecting device.

12. The shift control apparatus according to claim 1, wherein if a malfunction is detected in the first position information detecting device by the malfunction determining device at a time other than during a shift, a shift is not performed thereafter.
